(19) United States
(12) Patent Application Publication
(10) Pub. No.: US 2016/0104392 A1
(43) Pub. Date: Apr. 14, 2016

(54) EXTRACTING SEMANTIC FEATURES FROM COMPUTER PROGRAMS

(71) Applicant: ASPIRING MINDS ASSESSMENT PRIVATE LIMITED, New Delhi (IN)

(72) Inventors: Varun AGGARWAL, Gurgaon (IN); Shashank SRIKANT, Bangalore (IN)

(73) Assignee: ASPIRING MINDS ASSESSMENT PRIVATE LIMITED, New Delhi (IN)

(21) Appl. No.: 14/423,436

(22) PCT Filed: Jun. 20, 2014
(86) PCT No.: PCT/IB14/62481

§ 371 Date: Feb. 24, 2015

(30) Foreign Application Priority Data
Jun. 24, 2013 (IN) 1852/DEL/2013

(51) Int. Cl. G09B 19/00; G09B 7/02

(52) U.S. Cl. CPC G09B 19/0053; G09B 7/02

(57) ABSTRACT

The present invention provides a system and methods for extracting features from an object. The system comprises a receiver configured to receive an object comprising a set of instructions. Further, the system comprises an extraction module configured to extract one or more features of the object, wherein the one or more features comprise control-flow information, data-flow information, data-dependency information and control-dependency information. In an embodiment, the system includes an assessment module configured to assess at least one of functionality and quality of the first object, based on the features extracted and the grades corresponding to the second object.

### FIELD OF THE INVENTION

This is a national Stage application for PCT/IB2014/062481 having priority from Indian application 1852/DEL/2013.

The present invention relates to system and methods for extracting features of computer programs. In particular, the present invention relates to system and methods for extracting features of computer programs for automated grading.

### BACKGROUND

Software program evaluation has always been viewed from the perspective of correctness. This has been true for both cases of evaluating the software program as an application, and the software program used as a basis of assessing the programming skills of a programmer. Presently a software program is either said to be right or wrong but grading them on the level of correctness still largely remains elusive.

The software evaluation is of utmost importance when the software programs are used to assess a programmer for programming skills where a Boolean output does not suffice. Existing approaches assess proficiency manually by human assessors. In addition, the existing approaches also include a high operation cost, especially when large numbers of individuals are being assessed on an ongoing basis. However, there also exists a high cost for not performing proficiency assessments. Neglecting such assessments can lead to improper matching of skills to project requirements.

Presently there are several assessment tests such as Microsoft Certification, Java Certification and the like. However, all the tests only provide multiple-choice questions for the programmer to answer. The programmer does not perform the actual programming in the tests. As the result, a programmer without good programming skill can often achieve good grades by more rehearsals. On the other hand, a good programmer can get lesser grades due to the lack of exposure to the type of questions being asked in the test. This deficiency greatly reduces the credibility of the test results, and cannot provide a consistent and accurate measure of the genuine programming proficiency of the programmer. A good test for programming skill must have the programmer do the actual programming during the test. Hence, there is a requirement for a system for automatic assessment of programs.

The approach currently used for automatic assessment of programs is by evaluating the number of test cases they pass. However, programs that pass a high number of test cases may not be efficient and may have been written with bad programming practices. On the other hand, programs that pass a low number of test cases are many a-times quite close to the correct solution. Some unforced or inadvertent errors make them eventually fail the suite of test cases designed for the problem.

Another approach to the automated grading of programs makes use of measuring the similarity between abstract representations of a candidate's program and representations of correct implementations for the problem. However, the existence of multiple abstract representations for a correct solution to a given problem poses a problem to the implementation of this approach. In addition, there is an absence of an underlying rubric that guides the similarity metric and an absence of approaches to map the metric to the rubric discussed.

One common disadvantage associated with the prior art methods is that the parameters and features chosen for grading the software are not standardized and often involve lot of manual effort leading to increased cost.

In light of the above discussion, there is a need for a method and a system to automate the process of software grading.

### SUMMARY

The above-mentioned shortcomings, disadvantages and problems are addressed herein which will be understood by reading and understanding the following specification.

The present invention provides a system for grading including a receiver configured to receive at least one first object. The first object includes a set of instructions. The system includes extraction module configured to extract one or more semantic features of the first object, wherein the one or more features comprise control-flow information, data-flow information, data-dependency information and control-dependency information. The system also includes an assessment module configured to assess at least one of functionality of the first object, and quality of the first object, based on the features extracted and assign grades to the first object corresponding the assessment performed.

The second object graded using pre-determined parameters is graded by one or more individuals including but not limited to programming experts, students, faculty of academic institutions, working professionals with a relevant background and the like. The grading of the set of programs graded using pre-determined parameters includes but is not limited to an online portal, a crowd-sourced through an online platform, blogs related to programming, hand-graded assignments from computer courses in training institutions, through instructor assessed assignments from class, through contests devised for this purpose, and the like. The overall grade considered from the abovementioned sources include but are not limited to a monolithic grades pertaining to each grades, the consensus of two or more ratings and the like. The criteria to grade a program follow one or more rubrics that include but are not limited to code correctness, code efficiency, code readability, closeness of code logic to the correct logic of the program, existence of common mistakes and the like.

In an embodiment, the method to extract features from the computer programs includes counting the occurrences of one or more keywords and tokens appearing in the source code. In an embodiment, the extracting of features includes counting the number of variables declared, counting the occurrences of keywords used in the program such as ‘for’, ‘while’, ‘break’ and the like. In another embodiment, the extracting of features includes counting the occurrences of operators defined by a language such as ‘+’,‘−’,‘*’, ‘%’ and the like. In yet another embodiment, the extracting of features includes counting the number of character constants used in the program such as ‘0’, ‘1’, ‘2’, ‘100’ and the like. In another embodiment, the extracting of features includes counting the number of external function calls such as print( ), count( ), counting the number of unique data-types instantiated such as ‘integer’, ‘float’, ‘char’, ‘pointer to an integer’, and the like.

In another aspect, the present invention provides a computer program product comprising a computer usable medium having a computer readable program code embodied therein for grading objects. The computer program code receives at least one of first object and a second object. The first object and the second object comprise a set of instructions. The received second object is graded based on a set of pre-defined parameters. Further, the computer program product extracts one or more features of the first object. The one or more features comprise control-flow information, data-flow information, data-dependency information, control-dependency information. Further, the computer program product assesses at least one of functionality and quality of the first object, based on the features extracted and the grades corresponding to the second object.

### BRIEF DESCRIPTION OF THE DRAWINGS

FIG. 1 illustrates a system for assessing one or more objects, in accordance with embodiments of the present invention;

FIG. 2 illustrates a block diagram of a grading engine, in accordance with embodiments of the present invention; and

FIG. 3 illustrates a flowchart for assessing one or more objects, in accordance with embodiments of the present invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

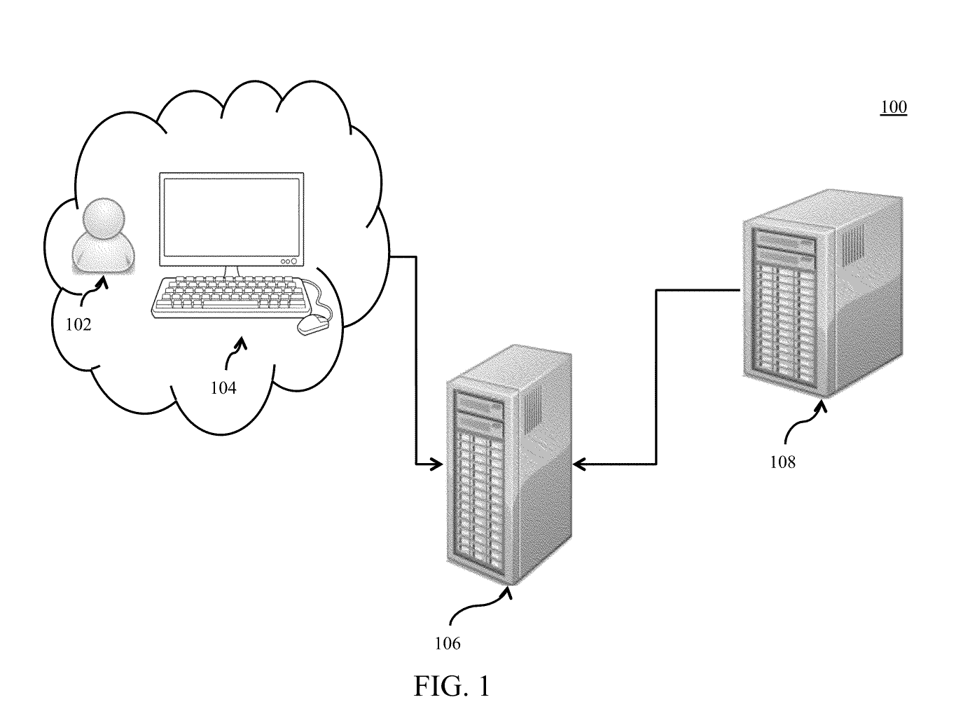

FIG. 1 illustrates a system 100 for assessing one or more objects, in accordance with embodiments of the present invention. The system 100 includes an input computer 104 communicating with a programmer 102. The programmer 102 enters an object into the input computer 104. In various embodiments, the object as described herein refers to, but is not limited to a computer program. The object may also refer to set of instructions being given to a machine, a command written in any computer language, and the like. Embodiments are now explained with respect to a computer program. In an embodiment, the programmer 102 is a professional writing a program in a programming language. In an example, the programmer 102 is a candidate taking up an online test. The online test includes a test for programming skills. In another example, the programmer 102 is an individual or community looking to learn computer programming. In yet another example, the programmer 102 is an individual or community in a Massive Open Online Course (MOOC). In yet another example, the programmer 102 is an individual or community participating in a Competitive Programming Contest.

The input computer 104 communicates with a grading engine 106. The grading engine 106 automatically grades the inputs from the input computer 104. The purpose of the grading engine includes but is not limited to a system to mimic human evaluation. In an example, the grading engine 106 aids in providing a feedback to the writer of the program. In another example, the grading engine 106 aids in providing feedback to a company or interviewer looking to hire candidates. In yet another embodiment, the grading engine 106 aids in providing feedback to aid learning of an individual or community. In yet another embodiment, the grading engine 106 aids in providing feedback to an individual or community in a Massive Open Online Course (MOOC), providing feedback to an individual or community in a Competitive Programming Contest.

The grading engine 106 communicates with a database 108. The database 108 stores a set of objects graded using pre-determined parameters. The grades given to the set of objects graded using pre-determined parameters are by one or more individuals. The one or more individuals include but are not limited to programming experts, students, faculty of academic institutions, working professionals with a relevant background and the like. The examples of the overall grade considered for the set of objects graded using pre-determined parameters can be a monolithic grades pertaining to each grades, the consensus of two or more ratings and the like.

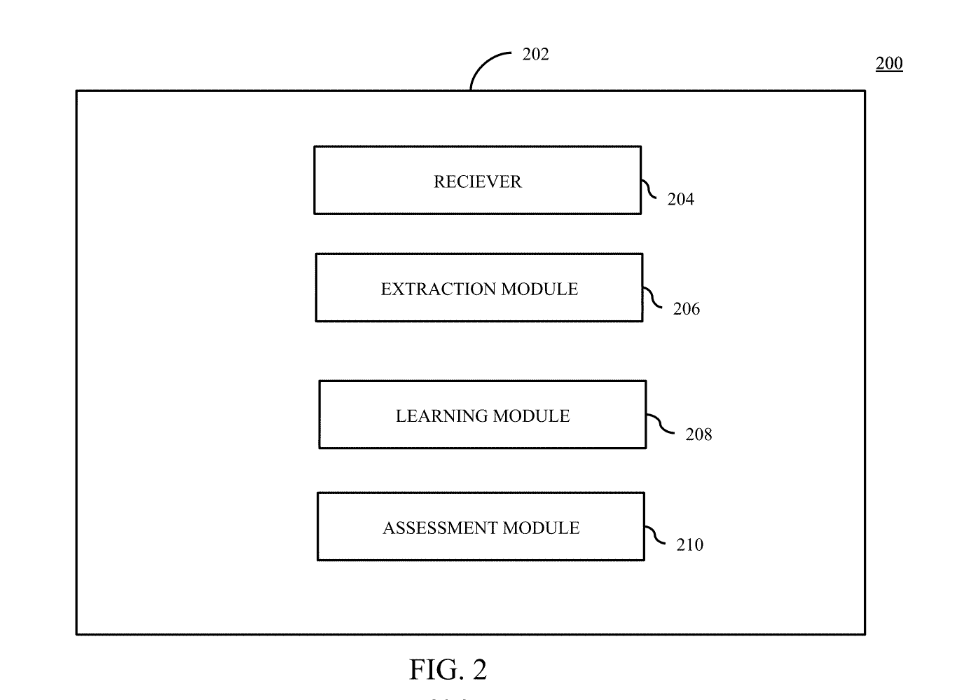

FIG. 2 illustrates a block diagram 200 of a grading engine 202, in accordance with various embodiments of the present invention. The functions and capabilities of the grading engine 202 are the same as the functions and capabilities of the grading engine 106. The grading engine 202 includes a receiver 204. The receiver 204 is configured to receive a first object from the input computer 104. The receiver 204 is also configured to receive a second object. In an embodiment, the first object is a computer program written by the programmer 102 in a programming language and a program graded using pre-determined parameters. The programming language follows a programming paradigm. The examples of the programming paradigm include, but are not limited to imperative programming, functional programming, procedural programming, event-driven programming, object-oriented programming, automata-based programming, declarative programming, and the like. The examples of the program language include but are not limited to C, C++, python, Java™, pseudo-language, assembly language, and graphics-based languages like Visual C™, Visual Basic™, Java™ Swing and the like.

The first object written by the programmer 102 is written to be compatible with any stage of compilation process. A stage of the compilation process includes but is not limited to, the program being written down via paper-pencil compilable and executable, checked for interpretation and compilation errors but not executable, interpreted or compilable and executable but has interpretation and compilation errors, interpreted, compilable, executable, and free of interpretation and compilation errors but has runtime errors and the like. A stage of completion includes but is not limited to, the computer program is complete program to solve a given functionality, partially complete, with the core functionality completely coded but certain auxiliary methods or functions left incomplete, written such that its core functionality is left incomplete, and the like.

The second object is graded using pre-determined parameters by one or more individuals including but not limited to programming experts, students, faculty of academic institutions, working professionals with a relevant background, and the like. The grading of the set of programs graded using pre-determined parameters includes but is not limited to an online portal, a crowd-sourced through an online platform, blogs related to programming, hand-graded assignments from computer courses in training institutions, through instructor assessed assignments from class, through contests devised for this purpose and the like. The overall grade considered from the abovementioned sources include but are not limited to a monolithic grades pertaining to each grades, the consensus of two or more ratings and the like. The criteria to grade a program follow one or more rubrics that include but are not limited to code correctness, code efficiency, code readability, closeness of code logic to the correct logic of the program, existence of common mistakes, and the like.

The grading engine 202 includes an extraction module 206. The extraction module 206 is configured to extract one or more features from the first object and the second object. The one or more features of the set of instructions corresponding to the first object are one of semantic, syntactic, lexical and morphological in nature. The extracted feature provide the information regarding the control-flow, data-flow, data dependency, control dependency and a combination of the abovementioned features. Abstract structures that represent information regarding the features extracted include but are not limited to control flow graphs, control dependence graphs, data-flow graphs, data dependence graphs, program dependence graphs, use-define chains and the like. These features are used to capture the semantic information of the object, which translates to the intentions of the programmer rather than just the correctness of the program.

In an embodiment, the method to extract features from the computer programs, is counting the occurrences of one or more keywords and tokens appearing in the source code. In an embodiment, the extracting of features is by counting the number of variables declared, counting the occurrences of keywords used in the program such as ‘for’, ‘while’, ‘break’ and the like. In another embodiment, the extracting of features is by counting the occurrences of operators defined by a language such as ‘+’,‘−’,‘*’, ‘%’ and the like. In yet another embodiment, the extracting of features is by counting the number of character constants used in the program such as ‘0’, ‘1’, ‘2’, ‘100’ and the like. In another embodiment, the extracting of features is by counting the number of external function calls such as print( ), count( ), counting the number of unique data-types instantiated such as ‘integer’, ‘float’, ‘char’, ‘pointer to an integer’ etc.

In an embodiment the count is made specific to the operators used, external functions called, constants used, data types used, such as counting the occurrences of ‘+’, ‘−’, ‘print’, ‘100’ and the like. In another embodiment, the count is made generic to counting just the total number of unique operators appearing, totally number of external function calls made, and the like. Abstract program structures used to extract the features include but are not limited to Abstract Syntax Trees, Control Flow Graphs, Data-flow Graphs, and the like.

In another embodiment, the method to extract features from the computer programs is by counting the occurrences of expressions containing various keywords and token. An expression in a programming language is a combination of explicit values, constants, variables, operators, and functions that are interpreted according to the particular rules of precedence and of association for a particular programming language, which computes and then produces another value. The method includes, but is not limited to, counting the number of expressions that contain one or more operators and one or more variables. In an embodiment, the count is made specific to the operators used, external functions called, constants used, variables used, the data-types of the variables used etc. in the expression. In an embodiment, the count is made generic to counting the total number of unique operators appearing, total number of external function calls and the like, in the expression. Abstract program structures that are used to extract these features can include but are not limited to abstract syntax trees and the like.

In yet another embodiment, the method to extract features from the computer programs, is to extract data-dependency features, which include but are not limited to, counting the occurrence of any particular kind of expression which is dependent on another expression. Such features include counting the occurrence of a set of dependent expressions wherein each expression may be dependent on any other expression in the set. This feature captures a plurality of dependencies of a particular expression on any another expression either in the same count or may count it in different counts. Abstract program structures used to extract the features include but are not limited to abstract syntax trees, data-flow graphs, data dependence graphs, program dependence graphs and the like.

In yet another embodiment, the method to extract features from the computer programs is by counting the occurrences of one or more expressions, keywords, tokens and the like, in context of the control-flow structure in which they appear. Such features include, but are not limited to, counting the number of times a particular expression, keyword, token and the like that appear within a hierarchical configuration that appears in the computer program. In an embodiment, the count is specific to the control-flow structures the features appear in, by maintaining separate counts for the occurrence of a loop. In another embodiment, the count is generic to counting the type of control-flow structure such as a loop. The abstract program structures that are used to extract these features include but are not limited to Abstract Syntax Trees, Control Flow Graphs, Control Dependence Graphs, Program Dependence Graphs and the like.

In yet another embodiment, the method to extract features from computer programs is counting the data dependencies and control dependencies of each variable instantiated in the program. In an embodiment, such features include, but are not limited to, counting use-define properties of a variable with the context of the control-flow structure in which it appears. In an embodiment, such features include, but are not limited to, counting use-define properties of a variable without the context of the control-flow structure in which it appears. The use-define properties of a variable includes counting the number of times a variable has been declared, number of times the variable is assigned, number of times the variable is assigned and the like. In an embodiment, the count is specific to the number of times it is assigned to a particular data-type, number of times it is assigned to a particular expression, number of times it is associated with a specific and with a generic operator and the like. The abstract program structures that are used to extract these features can include but are not limited to abstract syntax trees, use-define chains, control flow graphs, control dependence graphs, data-flow graphs, data dependence graphs, program dependence graphs and the like.

In accordance with various embodiments of the present invention, the grading engine 202 includes a learning module 208. The learning module 208 is configured to create a predictive model. The predictive model infers the input computer program for functional errors, logical errors and the like. Creating a predictive model includes but is not limited to using a machine learning technique, an expert driven technique, a rule-based technique and the like. A machine learning technique includes but is not limited to linear regression, generalized linear regression, ridge regression, neural networks, random-forests, bagging, boosting, genetic programming and the like. In an embodiment, the model is built on the whole data of set of programs graded using pre-determined parameters. In another embodiment, separate models are built for different grade ranges of the set of programs graded using pre-determined parameters.

The grading engine 202 includes an assessment module 210. The assessment module 210 applies the predictive model on the received computer program and evaluates said computer program. The received computer program is evaluated and provided one or more than one grades. The grades include but are not limited to grades representing how many test cases have passed, the confidence of the predicted grades, run-time parameters such as number of successful compilations made, number of buffer overruns and the like. Additionally, the grades are provided in any range that would make comparison of two grades possible. This includes but is not limited to alphabetical grades, integer grades in the range 0-100, fractional grades in the range 0-1 and the like.

In an embodiment, the grading engine 202 detects missing instructions in the set of instruction of the received first object. Further, the grading engine 202 fills in the missing instructions of the received first object. In another embodiment, the grading engine 202 detects duplication in the set of instructions of the received first object. In yet another embodiment, the grading engine 202 generates an application-programming interface for the received first object.

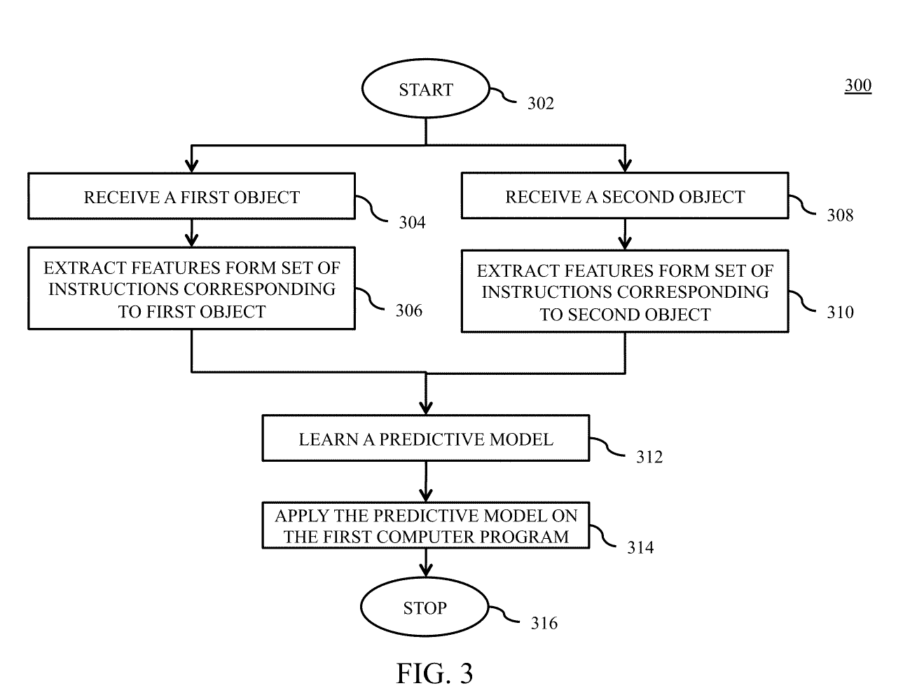

FIG. 3 illustrates a flowchart 300 for assessing one or more computer programs, in accordance with various embodiments of the present invention. The flow initiates at step 302. At step 304, the grading engine 106 receives a first object to be assessed. At step 306, features of the first object are extracted. As mentioned above, these features are used to capture the semantic information of the object, which translates to the intentions of the programmer rather than just the correctness of the program. The one or more features of the set of instructions corresponding to the first object capture the control-flow information, data-flow information, data dependency information, control dependency information and a combination of the abovementioned features.

At step 308, the grading engine 106 obtains a second object from the database 108. As mentioned above, the object is graded using pre-determined parameters by one or more individuals including but not limited to programming experts, students, faculty of academic institutions, working professionals with a relevant background, and the like.

At step 310, the grading engine 106 extracts features from the set of instructions corresponding to the second object. At step 312, the grading engine 106 creates a predictive model. As mentioned above, the predictive model infers the input object for functional errors, logical errors and the like. Creating a predictive model includes but is not limited to using a machine learning technique, an expert driven technique, a rule-based technique, and the like.

At step 314, the grading engine applies the predictive model on the first object and evaluates said first object. As mentioned above, the received first object is evaluated and provided one or more than one grades. The grades include but are not limited to grades representing how many test cases have passed, the confidence of the predicted grades, run-time parameters such as number of successful compilations made, number of buffer overruns and the like. The flow chart terminates at step 316.

This written description uses examples to describe the subject matter herein, including the best mode, and to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for grading, the system comprising:
a. a receiver configured to receive at least one first object, wherein the object comprises a set of instructions;
b. an extraction module configured to extract one or more features of the first object, wherein the one or more features comprise control-flow information, data-flow information, data-dependency information, and control-dependency information, and wherein the one or more features are expressed in quantitative values; and
c. an assessment module configured to assess at least one of functionality of the first object and quality of the first object, wherein the first object is assigned a grade based on the assessment.

2. The grading engine of claim 1, wherein the assessment module is configured to assess at least one of the quality of the first object and the functionality of the first object using the one or more extracted features based on a set of objects manually evaluated by a human operator.

3. The grading of claim 2, wherein the set of objects manually evaluated are evaluated by the human operator on at least one of quality of the set of objects and functionality of the set of objects.

4. The grading engine of claim 1, wherein the assessment module is configured to build a plurality of predictive models for assessing the first object, based on the set of objects manually evaluated.

5. The grading engine of claim 1, wherein the one or more features extracted by the extraction module are assigned alphanumerical values.

6. The grading engine of claim 1, wherein the grades provided to the first object comprise alphabetical grades, integer grades and fractional grades.

7. The grading engine of claim 1, wherein the received object comprises a set of instructions written in at least one of machine readable language and human readable translations thereof.

8. The grading engine of claim 1, wherein the features are extracted from the object at any stage of compilation of the object.

9. The grading engine of claim 1, wherein the features extracted by the extraction module are one or more of semantic, syntactic, lexical and morphological features.

10. A method for grading, the method comprising:
a. receiving at least a first object, wherein the object comprises a set of instructions;
b. extracting one or more features of the object, wherein the one or more features comprise control-flow information, data-flow information, data-dependency information, control-dependency information and wherein the one or more features are expressed in quantitative values;
c. assessing at least one of functionality of the object and quality of the first object wherein the first object is assigned a grade based on the assessment.

11. The method of claim 10, wherein the assessing at least one of the quality of the first object and the functionality first object is based on a set of objects manually evaluated.

12. The method of claim 10, wherein the set of objects are manually evaluated on at least one of quality of the set of objects and functionality of the set of objects.

13. The method of claim 10, comprising building a plurality of predictive models for assessing the first object, based on the set of objects evaluated by a human operator.

14. The method of claim 10, wherein the grades provided to the at least first object comprise alphabetical grades, integer grades and fractional grades.

15. The method of claim 10, wherein the received first object comprises a set of instructions written in at least one machine readable language and human readable translations thereof.

16. The method of claim 10, wherein the features are extracted from the received first object at any stage of compilation of the object.

17. The method of claim 14, wherein the grades provided to the received first object comprise alphabetical grades, integer grades and fractional grades.

18. The method as claimed in claim 13, wherein the method further comprises detecting duplication in the set of instructions associated with the received object.

19. The method as claimed in claim 13, wherein the features of the received first object are one or more of semantic, syntactic, lexical and morphological features.
